(19) United States
(12) Patent Application Publication
(10) Pub. No.: US 2008/0105109 A1
(43) Pub. Date: May 8, 2008

(54) KARAOKE APPARATUS AND METHOD THEREOF

(75) Inventors: Hung-Yuan Li, Taipei (TW); Chin-Peng Tsai, Taipei (TW); Show-Nan Chung, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ASUSTEK COMPUTER INC., Taipei (TW)

(21) Appl. No.: 11/470,258

(22) Filed: Sep. 6, 2006

(30) Foreign Application Priority Data
Sep. 22, 2005 (TW) 94132765

(51) Int. Cl. G10H 1/36

(52) U.S. Cl. 84/610; 84/616; 84/634

(57) ABSTRACT

A karaoke apparatus and the method thereof are provided, which guarantees the pitch of the karaoke music conforms to the pitch of the user. The apparatus comprises an audio input unit, a scale detector, a memory unit, a processor and a scale control unit. The audio input unit receives a test sound. The scale detector analyzes at least one test step of the test sound. The memory unit stores a plurality of standard steps. The processor finds out the highest step among the test steps, compares the highest step with the standard steps, and obtains a target step from the comparison; wherein, the target step is the standard step closest to the highest step. Finally, the scale control unit adjusts the pitch of the karaoke music so that the pitch is lower than that of the target step.

### CROSS-REFERENCE TO RELATED APPLICATION

This application claims the priority benefit of Taiwan application serial no. 94132765, filed on Sep. 22, 2005. All disclosure of the Taiwan application is incorporated herein by reference.

### BACKGROUND OF THE INVENTION

1. Field of Invention

The present invention relates to a karaoke apparatus and a method thereof. More particularly, the present invention relates to a karaoke apparatus and method thereof capable of finding out appropriate pitch of the karaoke music by testing sound.

2. Description of Related Art

When singing with a karaoke system, it is found frequently that the singer can not sing to reach the highest step or can not sing as low as the lowest step, which often influences the singer and the audience's mood. The reason for the problem is that the singer is unable to predict the pitch of the karaoke music and whether the pitch of the karaoke music conforms to the singer's pitch.

Even the conventional karaoke system utilizes the remote controller to adjust the pitch of the karaoke music, since the reason described above still exists, the perplexities such as the pitch is not high enough, the pitch is not low enough, or even the tuning may be worse that the pitch goes higher and higher or lower and lower.

Another solution is that, when the singer is singing, the karaoke system automatically adjusts the pitch of the karaoke music according to the singer's step. In such method, however, it is possible that the singer sings in a wrong step at the very beginning that he may himself raise or lower the step in the middle of the song. As a result, many times of proper adjustment may still be needed to get the appropriate pitch, which is not convenient.

### SUMMARY OF THE INVENTION

Accordingly, the present invention is directed to provide a kind of karaoke apparatus so as to guarantee the pitch of the karaoke music to conform to the pitch of the user.

The present invention is also directed to provide a karaoke method that can be used to adjust the karaoke music to the appropriate pitch of the karaoke music by one time adjustment only.

To achieve above and other purposes, the present invention provides a karaoke apparatus for singing and for karaoke music; the karaoke apparatus comprises an audio input unit, a scale detector, a memory unit, a processor and a scale control unit. The audio input unit receives a test sound. The scale detector analyzes at least one test step of the test sound. The memory unit stores a plurality of standard steps. The processor finds out the highest step among the test steps, compares the highest step with the standard steps, and obtains a target step from the comparison, wherein the target step is the standard step closest to the highest step. Finally, the scale control unit adjusts the pitch of the karaoke music so that the pitch is lower than that of the target step.

According to an embodiment, the test sound of the karaoke apparatus is provided by the user.

According to an embodiment, the target step of the karaoke apparatus is the standard step closest to the highest step, but substantially slightly lower than the highest step.

According to an embodiment, the karaoke apparatus further comprises a speaker, used for playing pitch-adjusted music.

According to an embodiment, each standard step of the karaoke apparatus has a corresponding code stored in the memory unit. The target code corresponding to the target step is stored in the memory unit.

According to an embodiment, the karaoke apparatus further comprises a remote control and a receiver; the remote control sends a control signal corresponding to the processor through the receiver. The processor selects the target code from the memory unit based on the control signal to set the pitch according to the target code.

Looking from another viewpoint that the present invention proposes a karaoke method which provides musical accompaniment for a singer. The method comprises the following steps: first, receiving at least one test sound; analyzing at least one test step of the test sound and finding out the highest step among the test steps; and comparing the highest step with a plurality of standard steps and obtaining a target step from the comparison, wherein the target step is the standard step closest to the highest step; finally, adjusting the pitch of the karaoke music so that the pitch is lower than that of the target step.

According to a preferred embodiment, the karaoke apparatus and method thereof of the present invention is to let the user test the sound first; find out the highest step the user can sing; compare the highest step with a plurality of standard steps to obtain a target step; and adjust the pitch of the karaoke music according to the target step so that the pitch is lower than that of the target step. Therefore, after testing the sound, only one time adjustment is needed to adjust the karaoke music to the right pitch, so that the pitch of the karaoke music conforms to the pitch of the user.

In order to the make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic block diagram of the karaoke apparatus according to an embodiment of the present invention.

FIG. 2 is a flow chart of the karaoke method according to an embodiment of the present invention.

### DESCRIPTION OF EMBODIMENTS

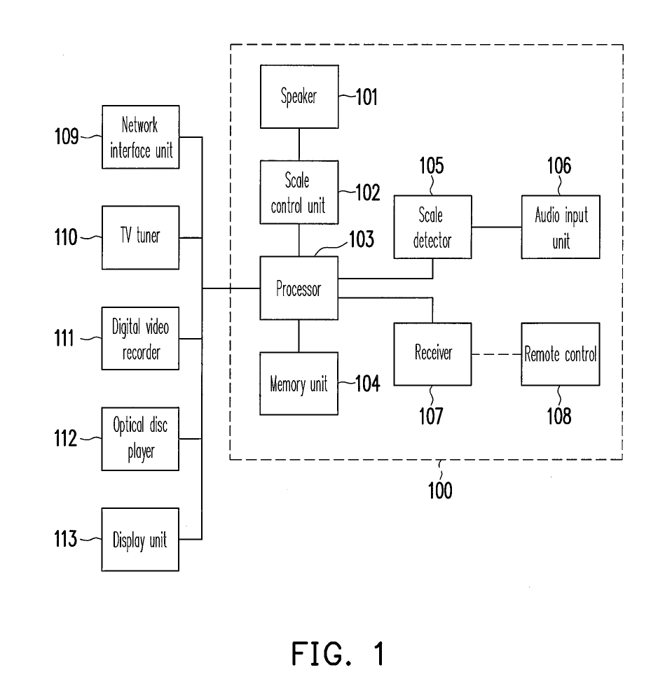

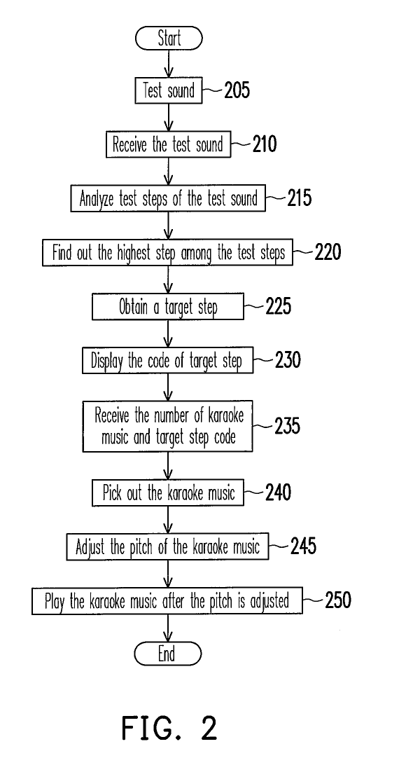

The preferred embodiment of the present invention will be explained with referring to FIG. 1 and FIG. 2. FIG. 1 is a block diagram of the karaoke apparatus 100 according to an embodiment of the present invention. FIG. 2 is a flow chat of the karaoke method according to an embodiment of the present invention. The karaoke apparatus 100 provided by this embodiment is used for singing and also providing karaoke music. As shown in FIG. 1, the karaoke apparatus 100 includes a speaker 101, a scale control unit 102, a processor 103, a memory unit 104, a scale detector 105, an audio input unit 106, a receiver 107 and a remote control 108. FIG. 1 further includes a network interface unit 109 connected to the karaoke apparatus 100 externally, a TV tuner 110, a digital video recorder (DCR) 111, an optical disc player 112 and a display device 113. The operation for those elements is detailed as follows.

As show in FIG. 2, in the step 205, the user presses down the key of test sound disposed on the remote control 108 for starting to test sound. In this embodiment, the communication between the remote control 108 and the receiver 107 is through infrared or wireless radio transmission. Therefore, when the user presses down the key of test sound, the remote control 108 can inform the processor 103 through the receiver 107. For example, the remote control 108 sends a control signal to the processor 103 through the receiver 107.

During the period of sound testing of the embodiment, the speaker 101 produces 30 standard steps from Do, Re, Mi, Fa continuously to let the user following the sounds and see how high the user can follow. In the step 210, the audio input unit 106 receives the test sound produced by the user. In this embodiment, the audio input unit 106 is a microphone, which is capable of converting the acoustic signals from the user into electric signals to output to the scale detector 105.

In the step 215, the scale detector 105 analyzes at least one test step of the test sound in step 215. Thereafter, in the step 220, the processor 103 finds out the highest step among the test steps. In the step 220, the processor 103 compares the highest step with a plurality of standard steps stored in the memory unit 104, for instance, the processor 103 compares the frequency of the steps in order to obtain a target step from the comparison, wherein the target step is the standard step closest to the user's highest step, but, in fact, slightly lower than the user's highest step. In this embodiment, the memory unit 104 can be a memory, such as a SDRAM or a DDRAM, a memory card, a disk drive or other device with similar function.

Each of the standard steps has a corresponding code, and the target step has a corresponding target code, too. Those codes are stored in the memory unit 104. In the step 230, the processor 103 displays the codes of the target steps by the display device 113 to show them to the user. The code of the target steps of the embodiment are represented by FIGS. 0˜29, but it is not limited by figures, letters or other symbols can also be used. In this embodiment, the display device 113 can be a traditional television, a LCD TV, a monitor, and so on.

After the user knows the code of the target step, in the step 235, the karaoke apparatus 100 receives the number of karaoke music and code of the target step. In this embodiment, the number of karaoke music and the code of the target step can be generated by one way, for instance, they can be generated through the user pressing a key disposed on the remote control 108. When the user presses the key of the remote control 108, the remote control 108 generates the control signals corresponding to the number of karaoke music and the code of the target step and then transmits the signals to the receiver 107, so that the receiver 107 receives the signals and outputs the signals to the processor 103 so as to select the number of karaoke music and the code of the target step stored in the memory unit 104 and displays them through the display device.

In the step 240, the processor 103 picks up the right karaoke music according to the number of karaoke music. The karaoke music can be provided by one of these sources: a built-in or an external memory unit, a built-in or an external disk drive, the network interface unit 109, the TV tuner 110, the digital video recorder (DCR) 111 or the optical disc player 112. The network interface unit 109 can be connected to a wire or a wireless network. The TV tuner 110 can be built-in into the TV set or the set-top box (STB) to receive wire or wireless, digital or analog signal. The disc read by the optical disc player 112 can be a compact disc (CD), a video compact disc (VCD), a digital versatile disc (DVD), a forward versatile disc (FVD) or a high definition DVD (HDDVD).

In the step 245, after picking up the right karaoke music, the processor 103 sets the pitch of the karaoke music according to the code of the target step, so that the scale control unit 102 adjusts the pitch of the karaoke music based on the setting of the processor 103 to make the pitch of the entire karaoke music be lower than that of the target step.

In the step 250, the speaker 101 plays the karaoke music in which the pitch has been adjusted. Due to the pitch of the karaoke music is lower than that of the target step, it guarantees that the user can sing well.

In addition, in the step 235, the sources of the number of karaoke music and the codes of the target step may make some changes. The sources of the number of karaoke music and the codes of the target step can be stored in the memory unit 104 in advance to save input time. If there is only one user to sing with the karaoke apparatus, the code of the target step just needs to input one time, and in the future the apparatus will adjust automatically. If there is a constant user, the individual code of the target step and the number of karaoke music which is sung frequently can be stored to the memory unit 104, so that repeated input is not needed in the future. Accordingly, it is more convenient and time-saving.

In summary, the karaoke apparatus and method thereof of the preferred embodiment of the present invention is to let the user test the sound first; find out the i5 highest step the user can sing; compare the highest step with a plurality of standard steps to obtain a target step; and adjust the pitch of the karaoke music according to the target step so that the pitch is lower than that of the target step. Therefore, after testing the sound, only one time adjustment is needed to adjust the karaoke music to the right pitch, so that the pitch of the karaoke music conforms to the pitch of the user.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A karaoke apparatus, used for singing and providing a music accompanying a user, comprising:
an audio input unit for receiving at least one test sound;
a scale detector for analyzing at least one test step of the test sound;
a memory unit for storing a plurality of standard steps;
a processor for finding out a highest step among the test steps, and then comparing the highest step with the standard steps to obtain a target step, wherein the target step is the standard step closest to the highest step; and
a scale control unit for adjusting a pitch of the music so that the pitch is lower than that of the target step.

2. The karaoke apparatus as claimed in claim 1, wherein the test sound is provided by the user.

3. The karaoke apparatus as claimed in claim 1, wherein the target step is the standard step closest to the highest step, but substantially slightly lower than the highest step.

4. The karaoke apparatus as claimed in claim 1, wherein the music is provided by one of these sources: a wire network, a wireless network, a TV tuner, a memory unit, a disk drive, a digital video recorder and an optical disc player.

5. The karaoke apparatus as claimed in claim 1, further comprising:
a speaker for playing the music after the pitch of the music has been adjusted.

6. The karaoke apparatus as claimed in claim 1, wherein the audio input unit is a microphone capable of converting an acoustic signal to an electric signal.

7. The karaoke apparatus as claimed in claim 1, wherein each standard step has a corresponding code stored in the memory unit, and the target step has a corresponding target code stored in the memory unit.

8. The karaoke apparatus as claimed in claim 7, further comprising:
a remote control and a receiver, wherein the remote control sends a control signal to the processor through the receiver so that the processor selects the target code from the memory unit based on the control signal to set the pitch according to the target code.

9. The karaoke apparatus as claimed in claim 8, wherein the remote control further includes at least one press key, the press key is used to input the target code; the scale control unit adjusts the pitch of the music at least one step up or down according to the target code.

10. A karaoke method for providing a music accompaniment when a user is singing, comprising:
receiving at least one test sound;
analyzing at least one test step of the test sound;
finding out a highest step among the test steps;
comparing the highest step with a plurality of standard steps and obtaining a target step, wherein the target step is the standard step closest to the highest step; and
adjusting a pitch of the music so that the pitch is lower than that of the target step.

11. The karaoke method as claimed in claim 10, wherein the test sound is provided by the user.

12. The karaoke method as claimed in claim 10, wherein the target step is the standard step closest to the highest step, but substantially slightly lower than the highest step.

13. The karaoke method as claimed in claim 10, wherein the music is provided by one of these sources: a wire network, a wireless network, a TV tuner, a memory unit, a disk drive, a digital video recorder and an optical disc player.

14. The karaoke method as claimed in claim 10, further comprising:
playing the music after the pitch has been adjusted.

15. The karaoke method as claimed in claim 10, wherein each the standard step has a corresponding code, and the target step has a corresponding target code.

16. The karaoke method as claimed in claim 15, further comprising:
receiving a control signal corresponding to the target code;
selecting the target code based on the control signal; and
setting the pitch of the music according to the target code.
